(19) United States
(12) Patent Application Publication
(10) Pub. No.: US 2021/0146508 A1
(43) Pub. Date: May 20, 2021

(54) APPARATUS FOR TIGHTENING THREADED FASTENERS

(71) Applicant: HYTORC Division UNEX Corporation, Mahwah, NJ (US)

(72) Inventors: Calvin A. Bonas, Bronx, NY (US); Peter Koppenhoefer, Portland, PA (US)

(73) Assignee: HYTORC Division UNEX Corporation, Mahwah, NJ (US)

(21) Appl. No.: 16/623,030

(22) PCT Filed: Jun. 14, 2018
(86) PCT No.: PCT/US2018/037462

§ 371 Date: Dec. 16, 2019

Related U.S. Application Data
(60) Provisional application No. 62/519,231, filed on Jun. 14, 2017.

(51) Int. Cl. B25B 13/48; B25B 13/06; B25B 23/00

(52) U.S. Cl. CPC B25B 13/481; B25B 13/06; B25B 23/0078; B25B 23/0028; B25B 23/0021

(57) ABSTRACT

This application discloses an apparatus 100 for use with an electrically, hydraulically and/or pneumatically driven torque tool for tightening or loosening inaccessible threaded fasteners including a drive extension assembly 110, a reaction assembly 120 and a socket assembly 130. Advantageously the present invention uses an external reaction member which holds on to two (2) or four (4) adjacent studs while turning a fastener with an extended drive ball and socket joint connection. It more efficiently distributes/reduces the side loads and system strains from the reaction forces on the bolts by bringing the reaction point much closer to the fastener being turned. It allows for a plurality of fastener approach angles and is adaptable to a plurality of fastener obstructions. It's relatively lightweight, easy to maneuver from fastener to fastener and overall user friendly.

### CROSS REFERENCE TO RELATED APPLICATIONS AND PATENTS

This application either claims priority to and/or is either a continuation patent application or a continuation-in-part application of the following commonly owned and/or co-pending patent application, an entire copy of which is incorporated herein by reference: U.S. Application Ser. No. 62/519,231, having Filing Date of 14 Jun. 2017, entitled “APPARATUS FOR TIGHTENING THREADED FASTENERS”.

### BACKGROUND OF THE INVENTION

Industrial bolting applications often include inaccessible fasteners. One such application is found on the Komatsu 980 Mining Truck 1 which includes rock service, tubeless, radial tires 2 having standard size of 59/80 R63 mounted on five piece flange rim assemblies 10, 1118 mm×1600 mm×140 mm (44″×63″×5.5″) in size. Tires 2 are rated at 758 kPa (110 psi) cold inflation pressure. A typical total tire weight comes to 32585 kg (71,838 lbs)! See Rim assemblies 10 include an inner, lower circumferential array of inaccessible fasteners 11 each requiring 1800-1900 ft·lbs. of torque, surrounded by an outer, higher circumferential array of fasteners 12. See FIGS. 1-3.

There is no room for conventional tooling to reach fasteners 11. A known tightening solution 50 requires use of a reaction fixture 51 shaped like a cross with a drive shaft extension 52. Known solution 50 reacts off of bolt heads on each side of reaction fixture 51 of a third circumferential array of fasteners 13 quite far from fasteners 11. This flawed solution puts excessive strain and side load on the system due to the positioning and angle ∠₅₀ of a socket 53, reaction fixture 51 and drive extension 52. Reaction points 55 and 56 are removed a distance H₅₀ from fasteners 11. Substantial risk of drive shaft extension 52, tool 40 and internal tool gearing failures and reaction fixture 51 slippages are characteristic of known solution 50. See FIGS. 4-5.

### SUMMARY OF INVENTION

This application discloses an apparatus 100 for use with an electrically, hydraulically and/or pneumatically driven torque tool for tightening or loosening inaccessible threaded fasteners including a drive extension assembly 110, a reaction assembly 120 and a socket assembly 130. Advantageously the present invention uses an external reaction member which holds on to two (2) or four (4) adjacent studs while turning a fastener with an extended drive ball and socket joint connection. It more efficiently distributes/reduces the side loads and system strains from the reaction forces on the bolts by bringing the reaction point much closer to the fastener being turned. It allows for a plurality of fastener approach angles and is adaptable to a plurality of fastener obstructions. It's relatively lightweight, easy to maneuver from fastener to fastener and overall user friendly. Compared to known tightening solution 50, apparatus 100 is a stable, secure, solid and compact system with no twisting or tendency to creep or crawl of off the reaction points.

### BRIEF DESCRIPTION OF THE DRAWINGS

FIG. 1 shows a side, perspective view of Komatsu 980 Mining Truck 1.

FIG. 2 shows a perspective view of five piece flange rim assemblies 10.

FIG. 3 shows a perspective view of a portion of inner, lower circumferential array of inaccessible fasteners 11.

FIGS. 5 and 6 show perspective views of known tightening solution 50.

FIGS. 6A, 6B and 6C show perspective, bottom and cross-sectional views, respectively, of apparatus 100 of the present invention.

FIG. 7 shows a perspective view of an apparatus 200 of the present invention.

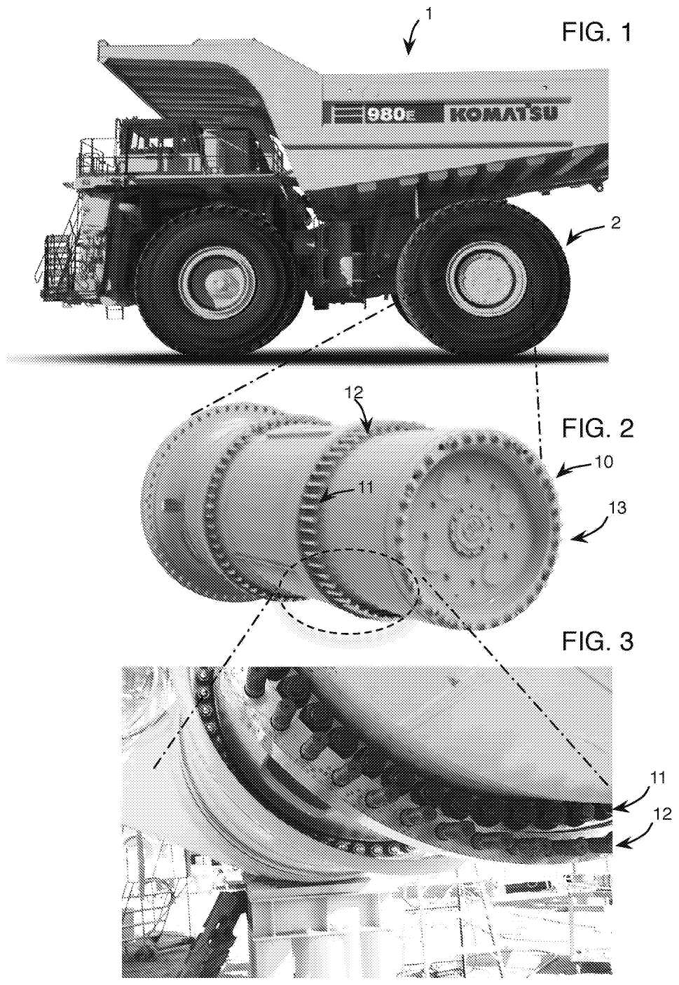

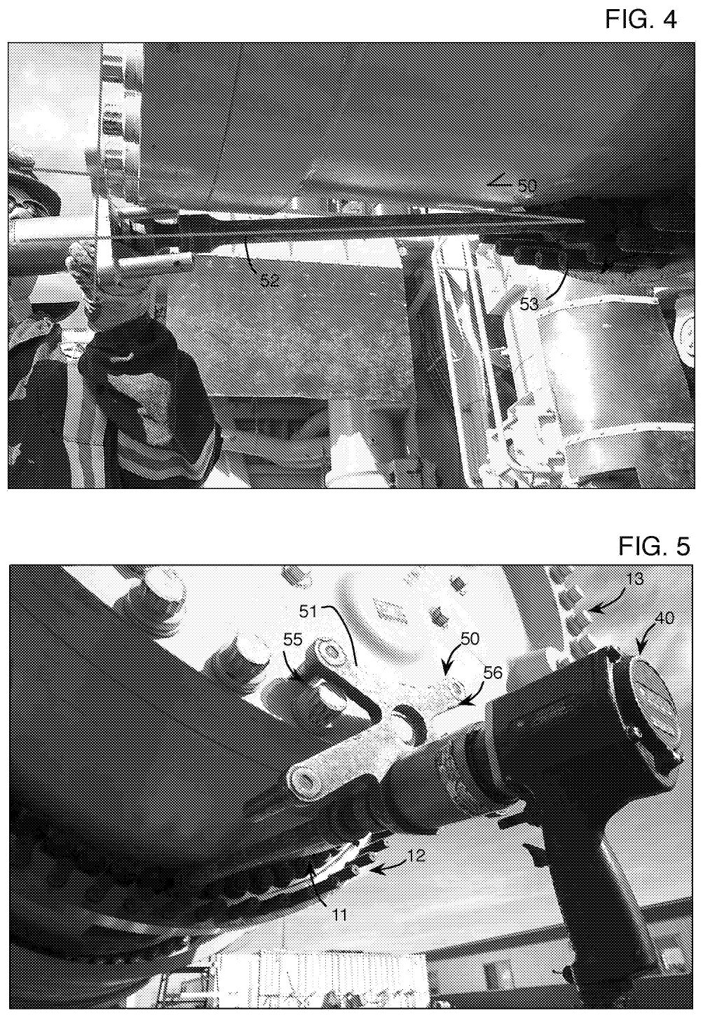

### DESCRIPTION

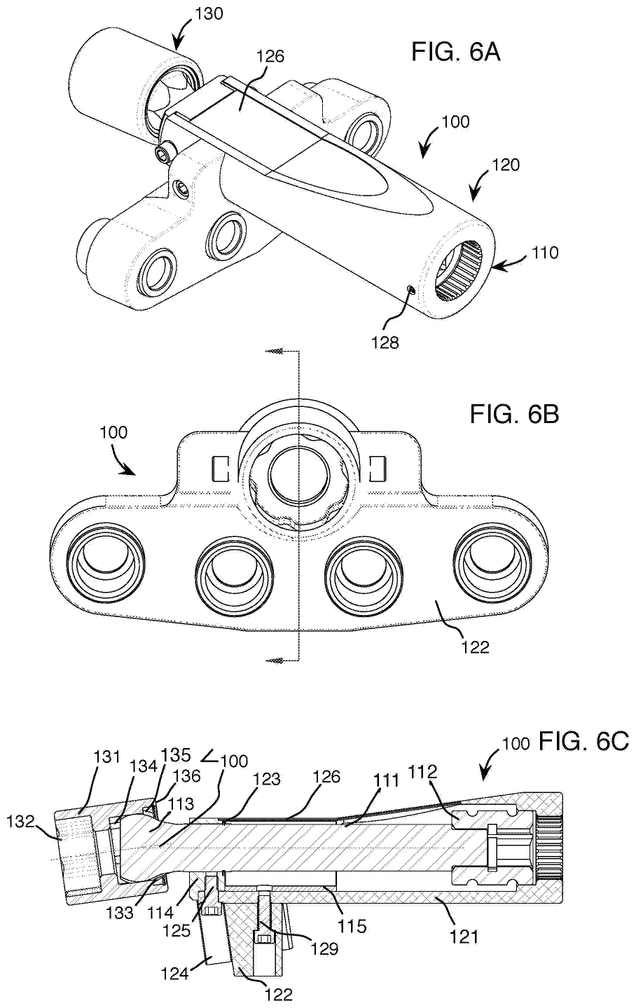

Referring to FIGS. 6A, 6B and 6C, by way of example, apparatus 100 includes drive extension assembly 110, reaction assembly 120 and socket assembly 130. Drive extension assembly 110 may include a drive extension 111, a drive connector 112, a drive extension hex ball 113, a drive guide bushing 114 and a shroud support sleeve 115. Reaction assembly 120 may include a reaction tube 121, a reaction plate 122, an external retaining ring 123, thread protector sleeves 124, SHCS 125, a dirt shield 126, a SHCS 128 and SHCSs 129. Socket assembly 130 may include a flank drive socket 131, a fastener engagement means 132, a ball flex means 133, a ball engagement means 134, an inner socket retaining ring 135 and an outer socket retaining ring 136.

During operation, apparatus 100 is assembled and coupled to, for example, a HYTORC pneumatic torque multiplier (not shown). Components of drive extension assembly 110 are inserted into reaction tube 121. Specifically, drive extension 111 is connected to drive connector 112 at one end and hex ball 113 of drive extension 111 is connected to flank drive socket 131 at another end. These items are supported and kept concentric to the system via drive guide bushing 114 and shroud support sleeve 115. Flank drive socket 131 is attached to hex ball 113 by retaining rings 135 and 136.

Reaction plate 122 is coupled to reaction tube 111 via SHCSs 129 and transfers the tool's equal and opposite reaction force to a plurality of studs of outer, higher circumferential array of fasteners 12. Thread protector sleeves 124 of reaction plate 122 prevents marking or damage to the studs. Dirt shield 126, attached to reaction tube 111 and held in place by drive guide bushing 114, seals off components of the system to improve safety and reduce foreign matter from getting on the internal drive contents.

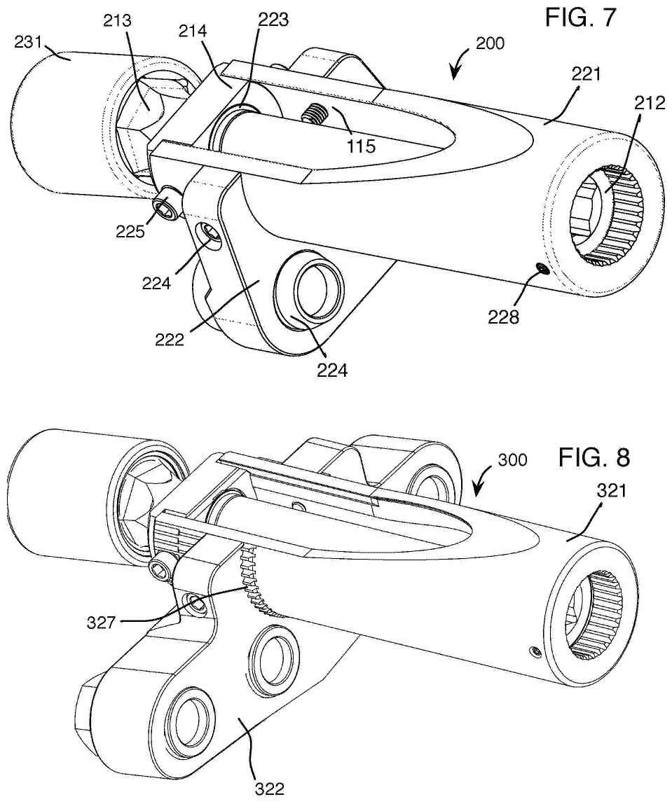

Another embodiment of the present invention is shown in FIG. 7. An apparatus 200 includes many of the same components as apparatus 100, evidenced by the similar numbering system. Notably, however, apparatus 200 reacts off of two (2) studs of outer, higher circumferential array of fasteners 12 rather than four (4) of them. Further, apparatus 200 does not include a dirt shield.

Another embodiment of the present invention is shown in FIG. 8. An apparatus 300 includes many of the same components as apparatus 100, evidenced by the similar numbering system. Notably, however, reaction plate 322 and reaction tube 321 are coupled via a spline connection means 327. Advantageously, spline connection means 327 allows for vertical displacement of reaction plate 322 and greater overall load support of apparatus 200. Further, apparatus 300 does not include a dirt shield.

It will be understood that each of the elements described above, or two or more together, may also find a useful application in other types of constructions differing from the types described above. The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof. Note that there may be slight differences in descriptions of numbered components in the specification.

While the invention has been illustrated and described as embodied in a fluid operated tool, it is not intended to be limited to the details shown, since various modifications, structural and component changes, size and materials changes, etc., may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

When used in this specification and claims, the terms “comprising”, “including”, “having” and variations thereof mean that the specified features, steps or integers are included. The terms are not to be interpreted to exclude the presence of other features, steps or components.

What is claimed is:

1. An apparatus for use with an electrically, hydraulically and/or pneumatically driven torque tool for tightening, loosening or both tightening and loosening of threaded assembly fasteners including:
a drive extension assembly;
a reaction assembly; and
a socket assembly.

2. An apparatus according to claim 1 including:
the drive extension assembly having a drive extension formed between a drive connector and a drive extension hex ball;
the reaction assembly having a reaction tube and a reaction plate; and
the socket assembly having a drive socket which accepts the fastener and the drive extension hex ball.

3. An apparatus according to claim 2 including:
the drive extension assembly having a drive guide bushing and a shroud support sleeve to support and keep concentric the drive connector and the drive extension within the reaction tube;
the reaction plate having a plurality of reaction engagements for a plurality of nearby fasteners; and
the socket assembly having a fastener engagement means, a ball flex means and a ball engagement means.

4. An apparatus according to claim 3 including:
the reaction assembly having a retaining ring, protection sleeves for the plurality of nearby fasteners and a dirt shield; and
the socket assembly having a plurality of retaining rings.

5. An apparatus according to claim 3 including two reaction engagements for two nearby fasteners.

6. An apparatus according to claim 3 including four reaction engagements for four nearby fasteners.

7. An apparatus according to claim 3 wherein the reaction tube and the reaction plate are coupled via a spline connection means.

8. An apparatus according to claim 3 wherein coupling of the drive extension hex ball and ball engagement means allows for engagement of the fasteners at a plurality of angles ∠.

9. An apparatus according to claim 1 wherein the drive extension assembly is substantially disposed inside the reaction assembly, and wherein the drive extension assembly and the reaction assembly are coupled together with a mechanism that allows such assemblies to be cooperatively and relatively rotated in opposite directions during operation.

10. An electrically, hydraulically and/or pneumatically driven torque tool for either tightening, loosening or both tightening and loosening of threaded fasteners including an apparatus according to either claim 1-9.

11. A system for fastening objects including:
a threaded fastener; and
a tool according to claim 10.

12. An apparatus, tool or system substantially as hereinbefore described with reference to and as shown in the accompanying drawings.

13. Any novel feature or novel combination of features described herein with reference to and as shown in the accompanying drawings.
